(19) United States
(12) Patent Application Publication
(10) Pub. No.: US 2014/0143168 A1
(43) Pub. Date: May 22, 2014

(54) Method and Apparatus for Work File and Profile Pool

(71) Applicant: PEOPLEMATTER, INC., (US)

(72) Inventor: Ken HAIGH, North Charleston, SC (US)

(73) Assignee: PEOPLEMATTER, INC., North Charleston, SC (US)

(21) Appl. No.: 13/683,576

(22) Filed: Nov. 21, 2012

(51) Int. Cl. G06Q 10/10

(52) U.S. Cl. CPC G06Q 10/105
USPC 705/320

(57) ABSTRACT

The present system provides a method and apparatus for automatically creating a profile for an individual based on an individual's biographical information, work history, awards and recognition, training, and certifications. The system captures the most recent update of an individual's biographical information when applying for a job or providing up to date information to an employer; records work history including job title and dates when an individual is hired, transferred, or promoted, or changes employment between companies; tracks the list of recognition and awards received by an individual; tracks the list of courses taken and successfully passed; captures any certifications earned; allows an individual to share some or all of the information to a prospective employers; allows an employer to search the collection of profiles; and enables auto-fill of information in an application form for a potential job opportunity.

### BACKGROUND

This patent application claims priority to U.S. Provisional Patent Application Ser. No. 61/536,346 filed on Nov. 23, 2011 which is incorporated by reference herein in its entirety.

The methodology used in hiring personnel and in matching candidates to positions has remain essentially unchanged over time. The typical process has been to identify the qualifications required for a position, to advertise the position, to accept applications for the position, to identify those candidates whose qualifications match to position, to conduct interviews with those candidates for the position, and to make a selection of a candidate to fill the position. Even the advent of the computer age has not changed this paradigm to any large degree. Computers have mainly been used to aid in the transmission of resumes and applications, the posting of available positions, and the storage of applications.

A problem with the hiring and candidate system is that there is no easy method for automatically updating the experiences, training, and resumes of candidates, no ability to provide permissions for allowing human resources to see some or all of a candidate's experience and training, and no central location to define a pool of candidates that would be suitable for a position.

### SUMMARY

The present system provides a method and apparatus for automatically creating a profile for an individual based on an individual's biographical information, work history, awards and recognition, training, and certifications. The system captures the most recent update of an individual's biographical information when applying for a job or providing up to date information to an employer; records work history including job title and dates when an individual is hired, transferred, or promoted, or changes employment between companies; tracks the list of recognition and awards received by an individual; tracks the list of courses taken and successfully passed through online training; captures any certifications earned through coursework; allows an individual to share some or all of the captured information to a prospective employers; allows an employer to search the collection of shared profiles; and enables auto-fill of information in an application form for a potential job opportunity.

### BRIEF DESCRIPTION OF THE DRAWINGS

FIG. 1 is a diagram illustrating an embodiment of the system.

FIG. 2 is a flow diagram illustrating updating in an embodiment of the system.

FIG. 3 is a flow diagram of an example search embodiment.

FIG. 4 is an example of a workfile in an embodiment of the system.

FIG. 5 is an example of the workfile after selecting the profile option.

FIG. 6 is an example computer embodiment of the system.

### DETAILED DESCRIPTION OF THE SYSTEM

The system provides a method and apparatus for tracking a pool of individuals, candidates, employees, potential employees, and/or workers with automatic updates as experience, education, and/or awards are obtained or earned by an individual. The system can be accessed by the individuals and employers or prospective employers. The system is not limited to the hiring/search process, but may also be used by employers to track their current employees to determine who might be suitable for promotion or new roles within an organization based on changes in individual profiles over time. The system also contemplates an auto-complete capability for completing applications and forms related to member individuals.

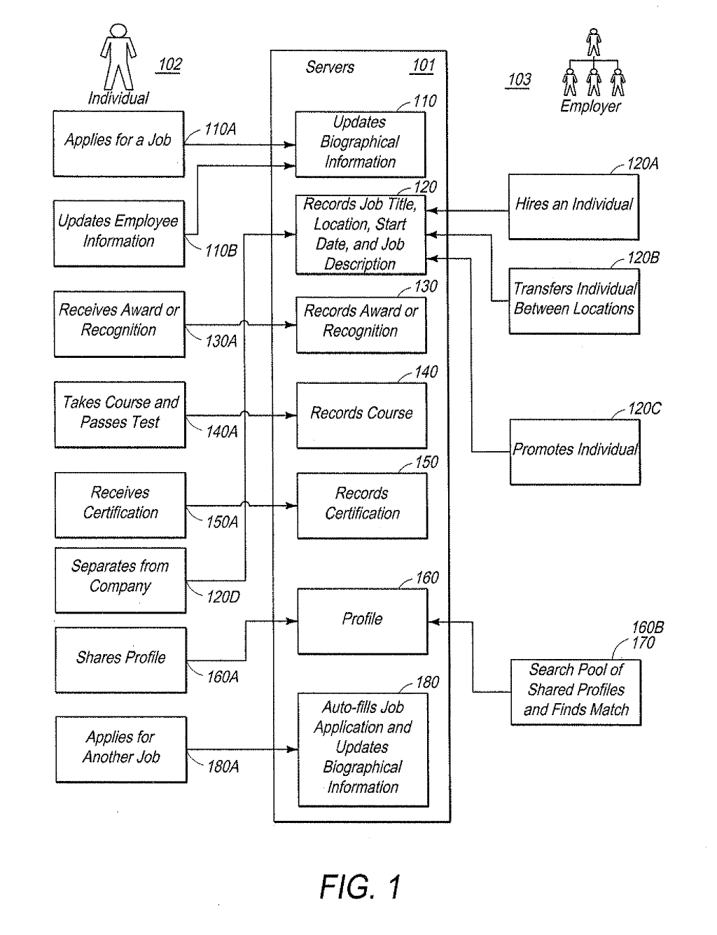

FIG. 1 is a diagram illustrating one embodiment of the system. The system comprises pool servers 101 that execute a plurality of functions and maintains data records related to activities of individual 102 and employer 103. In the figure, certain actions by an individual 101 and employer 102 are linked to functions within the servers 101. For purposes of example only, these activities are identified with related numbers. For example, activities related to the server function of “Updates Biographical Information” 110 are marked as elements 110A, 110B, and the like. Although referred to as “functions” herein, these may also be processing engines, databases, algorithms, and the like. In one embodiment, the servers 101 are implemented in a cloud computing environment. In another embodiment, the servers 101 are implemented at a system location.

Biographical Update

Function 110 of servers 101 handles the updating of biographical information. In one embodiment, this includes such information as employee name, address, and the like. Some of the activities of an individual that can result in a need for updating by function 110 include applying for a job 110A and updating employee information 110B. Activity 110B is contemplated as a manual update of biographical information by an employee. In one embodiment, employer activity does not impact the biographical function because the biographical function 110 comprises non-work information. In an alternate embodiment, and Employer may have access to Biographical function 110 via a human resources department, for example.

Employment History

Function 120 relates to updating and maintaining employment related information, such as job, title, start and end date, job description, location, and the like. Most of the employer activity impacts this function, including hiring 120A, transfers, 120B, promotions 120C, and the like. Individual activities such as separating from the company 120D (shown here as an employee activity) will also cause updates at function 120.

Awards and Recognition

Function 130 tracks awards and other recognition obtained by, or given to, an individual, This function is typically updated by the individual when such recognition is achieved 130A.

Education and Certification

Functions 140 and 150 track education and training certification of an individual. When individual 102 completes a course 140A and satisfies its requirements (e.g. passes a test) the servers 101 update the database to reflect the additional education of the individual. Similarly, if an individual attains or receives a certification 150A, the system updates the database to reflect the change in status.

Profile

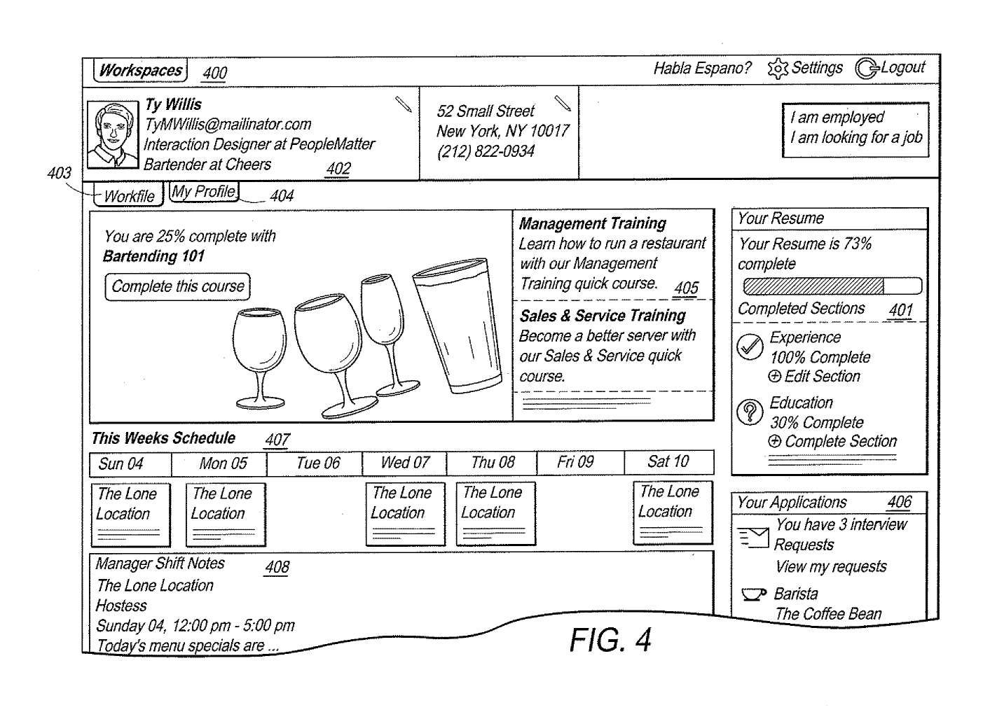

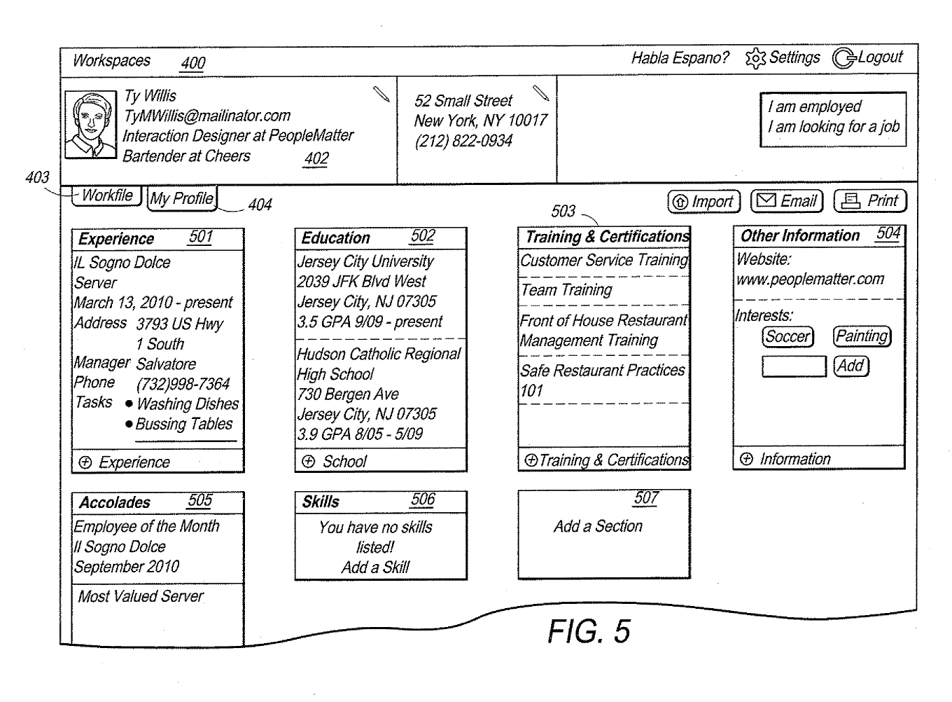

The profile functionality 160 takes advantage of the fact that the system maintains information about a plurality of individuals. This allows an employer to define and search for specific profiles of individuals who might satisfy an opening for a position. The employer 103 searches 160B the pool to find one or more matches to the defined profile of a particular position to be filled. An individual 102 can share his profile 160A and edit and/or determine which individual data is shared in the profile function 160. This allows the individual 102 to redact certain positions or other information that might be extraneous to, or reduce the chances with respect to, a particular offered position. In one embodiment, the profile is also referred to as a “workfile” and may be as described below in connection with FIG. 4,

AutoFill

Function 180 is an auto-fill function for updating information related to the individual. When an individual 102 applies for a job 180A using the system, the auto-fill function automatically updates the employment and biographical information databases of the servers 101 accordingly. This aids in keeping all information current and accurate. The system always allows the individual to manually check, edit, and update information as appropriate.

Operation

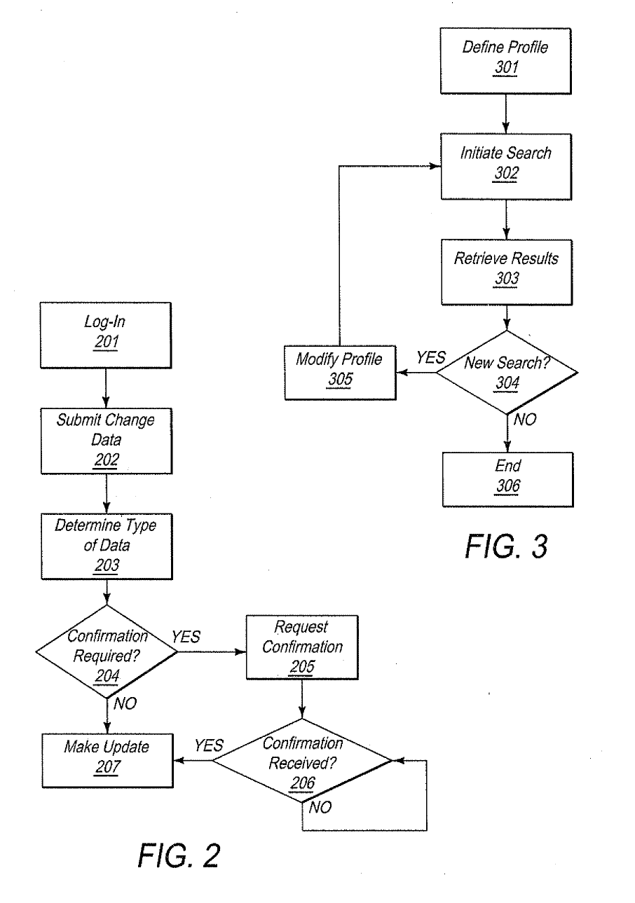

FIG. 2 is a flow diagram illustrating the operation of the system in one embodiment showing the updating of information from an individual 102. At step 201 the individual logs into the system. In one embodiment this is via a previously arranged login name and password. At step 202 the individual submits proposed update data. At step 203 the identifies the type of data that is being submitted (e.g. biographical, educational, etc.). At decision block 204 the system determines if authorization or confirmation is required to update the data. For example, for some educational submissions or certifications, some confirmation code or third party acknowledgement may be required.

If confirmation is required at step 204, the system requests confirmation from the individual at step 205. At decision block 206 the system determines if the confirmation has been received. If no confirmation is received, the system returns to step 206 to wait for confirmation.

If the confirmation is provided at step 206, or if no confirmation is required at step 204, the system proceeds to step 207 and updates the appropriate database.

FIG. 3 is a flow diagram illustrating the operation of the system by an employer 103 to search for candidates. At step 301 the employer 103 defines a profile for the position to be filled. At step 302 the employer initiates a search in the system for candidates matching the profile. At step 303 the system retrieves all candidates meeting the profile query.

At decision block 304 it is determined if the employer wants to do another search. If so, the employer modifies the search at step 305 and returns to step 302. If not, the system ends at step 306.

WorkSpaces

FIG. 4 is an example embodiment of a workspace 400 that includes tabs to access a workfile 403 or user profile 404. In the example shown, the user has selected the Workfile tab 403. In one embodiment, the workfile is an interactive computer based page that can also be printed as a hard copy as desired. In one embodiment the workfile can be accessed by the individual, an employer, HR, educational resources, and the like. However, each type of person with access may have different permission levels to modify the profile, as described in connection with FIG. 1.

The workfile can provide information, such as region 401, that is seen only by the individual to provide information about the completeness of the workfile. In the example shown, the workfile is 73% complete and the region identifies additional aspects (e.g. education, training and certification, skills, and the like) that require attention.

The workfile 403 also may include a region 402 of identifying information, including the individual's name, contact information, certifications, picture, and the like. In the embodiment shown, the workfile includes a region 405 that provides a reminder of a current activity of the user. In the example shown, the system presents the status of a current course (e.g. bartending) that the user is taking and informs the user of the completeness of the course. The system also includes suggestions from the system to the individual to improve their hiring chances. In the example shown, the individual is in a food service job. Thus, the region recommends food service training such as management, food management, and the like.

Region 407 includes the current work schedule of the user. This region may be updated by the employer, providing an easy way to convey information to employees. Region 408 includes shift notes that provide additional information about information relevant to the user's employment.

Region 406 displays interview requests that the user has pending for other employment. Even though a current employer can update the user's workfile in regions related to work, the employer cannot update, or view, regions that are specific and personal to the user, such as other job applications.

FIG. 5 illustrates the workspace when the “Profile” tab 404 is selected. The profile may also include the education 502 of the individual, as well as the work history 501. The profile can also include certificates and training 503 and awards and accolades 505. The certificates can also be presented as a list as well.

Region 504 shows other information about the user, including a linked website and other interests. A region 506 is where the user can include a list of skills. The system is customizable and the user can add sections to the profile as desired, such as “Add a Selcetion” region 507.

As noted above, the workfile may be populated automatically based on experiences, training, and awards earned by the individual. In addition, the workfile will have different appearances depending on who is viewing the workfile.

Embodiment of Computer Execution Environment (Hardware)

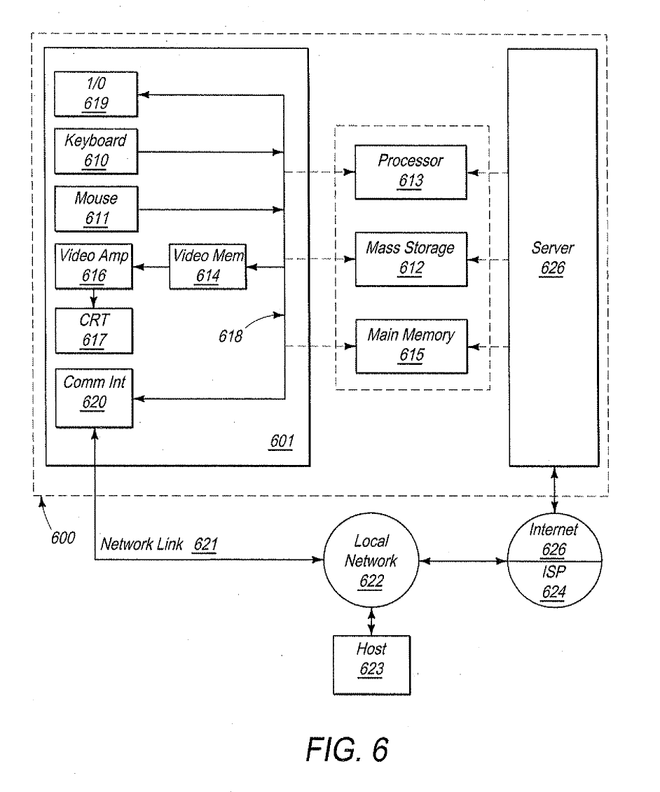

An embodiment of the system can be implemented as computer software in the form of computer readable program code executed in a general purpose computing environment such as environment 600 illustrated in FIG. 6, or in the form of bytecode class files executable within a Java™ run time environment running in such an environment, or in the form of bytecodes running on a processor (or devices enabled to process bytecodes) existing in a distributed environment (e.g., one or more processors on a network). A keyboard 610 and mouse 611 are coupled to a system bus 618. The keyboard and mouse are for introducing user input to the computer system and communicating that user input to central processing unit (CPU 613. Other suitable input devices may be used in addition to, or in place of, the mouse 611 and keyboard 610. I/O (input/output) unit 619 coupled to bi-directional system bus 618 represents such I/O elements as a printer, AN (audio/video) I/O, etc.

Computer 601 may be a laptop, desktop, tablet, smart-phone, or other processing device and may include a communication interface 620 coupled to bus 618. Communication interface 620 provides a two-way data communication coupling via a network link 621 to a local network 622. For example, if communication interface 620 is an integrated services digital network (ISDN) card or a modem, communication interface 620 provides a data communication connection to the corresponding type of telephone line, which comprises part of network link 621. If communication interface 620 is a local area network (LAN) card, communication interface 620 provides a data communication connection via network link 621 to a compatible LAN. Wireless links are also possible. In any such implementation, communication interface 620 sends and receives electrical, electromagnetic or optical signals which carry digital data streams representing various types of information.

Network link 621 typically provides data communication through one or more networks to other data devices. For example, network link 621 may provide a connection through local network 622 to local server computer 623 or to data equipment operated by ISP 624. ISP 624 in turn provides data communication services through the world wide packet data communication network now commonly referred to as the “Internet” 626 Local network 622 and Internet 626 both use electrical, electromagnetic or optical signals which carry digital data streams. The signals through the various networks and the signals on network link 621 and through communication interface 620, which carry the digital data to and from computer 600, are exemplary forms of carrier waves transporting the information.

Processor 613 may reside wholly on client computer 601 or wholly on server 626 or processor 613 may have its computational power distributed between computer 601 and server 626. Server 626 symbolically is represented in FIG. 6 as one unit, but server 626 can also be distributed between multiple “tiers”. In one embodiment, server 626 comprises a middle and back tier where application logic executes in the middle tier and persistent data is obtained in the back tier. In the case where processor 613 resides wholly on server 626, the results of the computations performed by processor 613 are transmitted to computer 601 via Internet 626, Internet Service Provider (ISP) 624, local network 622 and communication interface 620. In this way, computer 601 is able to display the results of the computation to a user in the form of output.

Computer 601 includes a video memory 614, main memory 615 and mass storage 612, all coupled to bi-directional system bus 618 along with keyboard 610, mouse 611 and processor 613.

As with processor 613, in various computing environments, main memory 615 and mass storage 612, can reside wholly on server 626 or computer 601, or they may be distributed between the two. Examples of systems where processor 613, main memory 615, and mass storage 612 are distributed between computer 601 and server 626 include thin-client computing architectures and other personal digital assistants, Internet ready cellular phones and other Internet computing devices, and in platform independent computing environments,

The mass storage 612 may include both fixed and removable media, such as magnetic, optical or magnetic optical storage systems or any other available mass storage technology. The mass storage may be implemented as a RAID array or any other suitable storage means. Bus 618 may contain, for example, thirty-two address lines for addressing video memory 614 or main memory 615. The system bus 618 also includes, for example, a data bus for transferring data between and among the components, such as processor 613, main memory 615, video memory 614 and mass storage 612. Alternatively, multiplex data/address lines may be used instead of separate data and address lines.

In one embodiment of the invention, the processor 613 is a microprocessor such as manufactured by Intel, AMD, Sun, etc. However, any other suitable microprocessor or microcomputer may be utilized, including a cloud computing solution. Main memory 615 is comprised of dynamic random access memory (DRAM). Video memory 614 is a dual-ported video random access memory. One port of the video memory 614 is coupled to video amplifier 619. The video amplifier 619 is used to drive the cathode ray tube (CRT) raster monitor 617. Video amplifier 619 is well known in the art and may be implemented by any suitable apparatus. This circuitry converts pixel data stored in video memory 614 to a raster signal suitable for use by monitor 617. Monitor 617 is a type of monitor suitable for displaying graphic images.

Computer 601 can send messages and receive data, including program code, through the network(s), network link 621, and communication interface 620. In the Internet example, remote server computer 626 might transmit a requested code for an application program through Internet 626, ISP 624, local network 622 and communication interface 620. The received code maybe executed by processor 613 as it is received, and/or stored in mass storage 612, or other non-volatile storage for later execution. The storage may be local or cloud storage. In this manner, computer 600 may obtain application code in the four of a carrier wave. Alternatively, remote server computer 626 may execute applications using processor 613, and utilize mass storage 612, and/or video memory 615. The results of the execution at server 626 are then transmitted through Internet 626, ISP 624, local network 622 and communication interface 620. In this example, computer 601 performs only input and output functions.

Application code may be embodied in any form of computer program product. A computer program product comprises a medium configured to store or transport computer readable code, or in which computer readable code may be embedded. Some examples of computer program products are CD-ROM disks, ROM cards, floppy disks, magnetic tapes, computer hard drives, servers on a network, and carrier waves.

The computer systems described above are for purposes of example only. In other embodiments, the system may be implemented on any suitable computing environment including personal computing devices, smart-phones, pad computers, and the like. An embodiment of the invention may be implemented in any type of computer system or programming or processing environment.

Thus, a method and apparatus for providing content from a plurality of sources is described.

What is claimed is:

1. A human resources system for maintain work profiles comprising:
in a third party processing system;
a first database changeable only be an employee for storing biographical information about the employee;
a second database changeable by the employee and an employer for storing job related information about the employee;
a job application engine for accessing the first and second databases and for automatically completing a job application;
a profile pool for sharing profiles of a plurality of applicants and accessible by the employee and the employer.

2. The system of claim 1 wherein the databases are implemented on a cloud based server system.

3. The system of claim 1 further including a records database to store certification and educational achievements of the employee.

4. The system of claim 3 further including a records certification engine for confirming certifications and educational achievements of the employee.

5. A method of maintaining human resources data comprising:
providing a third party database of employee and employer information;
providing the employee access to a first set of data in the database;
providing the employer access to a second set of data in the database;
providing an engine for automatically updating the first set and second set of data when changes occur.

6. The method of claim 5 further including a certification engine for certifying when the employee has completed a course.

7. The method of claim 5 wherein the third party database is implemented in a cloud computing system.
